(19) United States
(12) Patent Application Publication
(10) Pub. No.: US 2025/0149540 A1
(43) Pub. Date: May 8, 2025

(54) POSITIVE ELECTRODE FOR SECONDARY BATTERY, AND SECONDARY BATTERY

(71) Applicant: Panasonic Energy Co., Ltd., Moriguchi-shi, Osaka (JP)

(72) Inventor: Tomohiro Harada, Osaka (JP)

(73) Assignee: Panasonic Energy Co., Ltd., Moriguchi-shi, Osaka (JP)

(21) Appl. No.: 18/832,224

(22) PCT Filed: Jan. 19, 2023
(86) PCT No.: PCT/JP2023/001459

§ 371 Date: Jul. 23, 2024

(30) Foreign Application Priority Data
Jan. 26, 2022 (JP) 2022-010209

(51) Int. Cl. H01M 4/131; H01M 4/02; H01M 4/62

(52) U.S. Cl. CPC H01M 4/131; H01M 4/623; H01M 2004/028

(57) ABSTRACT

This positive electrode for a secondary battery is characterized in that: the positive electrode for a secondary battery comprises a positive electrode current collector, and a positive electrode mixture layer which is disposed on the positive electrode current collector and which includes a positive electrode active substance and a binder; the binder contains a polymer binder having a three-dimensional mesh structure; and if the positive electrode mixture layer is divided into two equal parts in the thickness direction, with the lower half on the positive electrode current collector side set as a first region and the upper half on the side of surface of the positive electrode mixture layer set as a second region, the first region contains more of the polymer binder having a three-dimensional mesh structure than the second region.

### TECHNICAL FIELD

The present disclosure relates to a positive electrode for a secondary battery and a secondary battery.

### BACKGROUND

As a positive electrode for a secondary battery used in a secondary battery, for example, Patent Literature 1 discloses a sheet-like electrode obtained by forming a mixture film in which active material particles are bound by a polymer binder having a network structure and a polymer solid electrolyte on a conductive substrate.

In addition, for example, Patent Literature 2 discloses a positive electrode for a non-aqueous electrolyte secondary battery including a positive electrode current collector, a positive electrode mixture layer containing a positive electrode active material and a binder, and an intermediate layer located between the positive electrode current collector and the positive electrode mixture layer and containing a conductive agent and a binder, in which a mass average molecular weight of the binder in the intermediate layer is greater than a mass average molecular weight of the binder in the positive electrode mixture layer.

In addition, for example, Patent Literature 3 discloses a method for manufacturing an electrode for a secondary battery, the method including: applying a slurry for a first layer onto a surface of a current collector; applying a slurry for a second layer onto the slurry for a first layer before the slurry for a first layer is dried; and drying the slurry for a first layer and the slurry for a second layer after the slurry for a first layer and the slurry for a second layer are applied to obtain a laminated structure in which a first layer and a second layer are laminated in this order on the current collector, in which a viscosity of a first solution used for the slurry for a first layer is greater than a viscosity of a second solution used for the slurry for a second layer.

In addition, for example, Patent Literature 4 discloses a non-aqueous electrolyte secondary battery including: a positive electrode in which a positive electrode active material layer containing a positive electrode active material and a binder is provided on an aluminum core; a negative electrode; and a non-aqueous electrolyte containing a non-aqueous solvent and an electrolyte salt, in which the positive electrode active material layer has an A layer formed on the aluminum core and formed using a binder composed of polyvinylidene fluoride having a weight average molecular weight of greater than or equal to 500,000 and less than or equal to 1,000,000, and a B layer formed on the A layer and formed using a binder composed of polyvinylidene fluoride having a weight average molecular weight of greater than or equal to 150,000 and less than or equal to 400,000.

### CITATION LIST

### Patent Literature

Patent Literature 1: JP H10-106540 A
Patent Literature 2: WO 2016/024394 A
Patent Literature 3: JP 2019-96501 A
Patent Literature 4: JP 2009-259699 A

### SUMMARY

An object of the present disclosure is to provide a positive electrode for a secondary battery and a secondary battery capable of suppressing an increase in direct current resistance (DCR) when charging and discharging of the battery are repeated.

According to one aspect of the present disclosure, a positive electrode for a secondary battery includes a positive electrode current collector, and a positive electrode mixture layer that is provided on the positive electrode current collector and contains a positive electrode active material and a binder, in which the binder includes a polymer binder having a three-dimensional network structure, and in a case where the positive electrode mixture layer is divided into two in a thickness direction, a lower half on a side of the positive electrode current collector is defined as a first region, and an upper half on a surface side of the positive electrode mixture layer is defined as a second region, the first region contains more of the polymer binder having a three-dimensional network structure than the second region.

In addition, according to one aspect of the present disclosure, a positive electrode for a secondary battery includes a positive electrode current collector, and a positive electrode mixture layer that is provided on the positive electrode current collector and contains a positive electrode active material and a binder having a PVDF skeleton,

in which in a case where the positive electrode mixture layer is divided into two in a thickness direction, a lower half on a side of the positive electrode current collector is defined as a first region, and an upper half on a surface side of the positive electrode mixture layer is defined as a second region, a generation initiation temperature of a peak observed from a temperature-chromatogram curve for a mass-to-charge ratio (m/z)=132 obtained by evolved gas analysis-mass spectrometry (EGA-MS) for the first region is higher than a generation initiation temperature of a peak observed from a temperature-chromatogram curve for a mass-to-charge ratio (m/z)=132 obtained by evolved gas analysis-mass spectrometry (EGA-MS) for the second region.

In addition, according to one aspect of the present disclosure, a secondary battery includes the positive electrode for a secondary battery.

According to one aspect of the present disclosure, it is possible to provide a positive electrode for a secondary battery and a secondary battery capable of suppressing an increase in direct current resistance (DCR) when charging and discharging of the battery are repeated.

### BRIEF DESCRIPTION OF DRAWINGS

FIG. 1 is a schematic cross-sectional view of a secondary battery as an example of an embodiment.

FIG. 2 is a schematic cross-sectional view of a positive electrode as an example of an embodiment.

FIG. 3 is a cross-sectional view of a positive electrode as another example of the embodiment.

### DESCRIPTION OF EMBODIMENTS

Hereinafter, an example of a secondary battery according to one aspect of the present disclosure will be described.

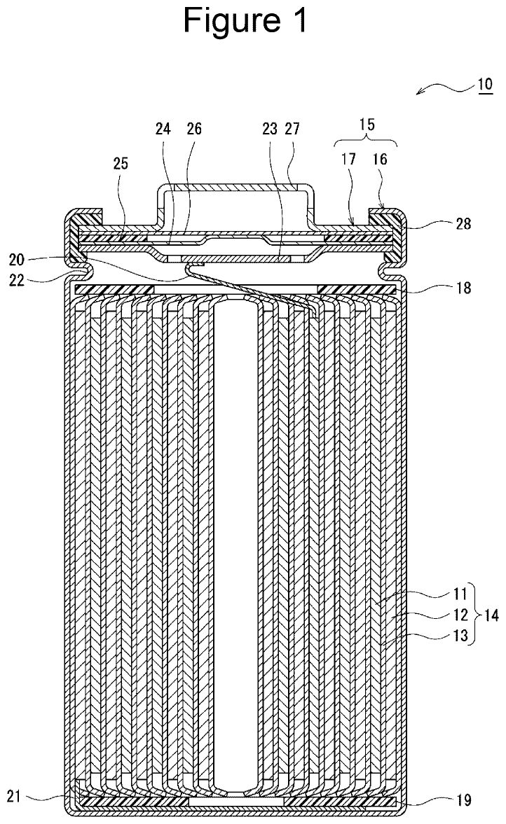

FIG. 1 is a schematic cross-sectional view of a secondary battery as an example of an embodiment. A secondary battery 10 illustrated in FIG. 1 includes a wound electrode assembly 14 formed by wounding a positive electrode 11 and a negative electrode 12 with a separator 13 interposed between the positive electrode and the negative electrode, an electrolyte, insulating plates 18 and 19 that are disposed on upper and lower sides of the electrode assembly 14, respectively, and a battery case 15 housing the members. The battery case 15 includes a bottomed cylindrical case body 16 and a sealing assembly 17 for closing an opening of the case body 16. Note that, instead of the wound electrode assembly 14, an electrode assembly having another form, such as a stacked electrode assembly in which positive electrodes and negative electrodes are alternately stacked with separators interposed therebetween, may be applied. Examples of the battery case 15 include metal cases having a cylindrical shape, a square shape, a coin shape, a button shape, or the like, and resin cases (so-called laminated type) formed by lamination with a resin sheet.

The electrolyte may be an aqueous electrolyte, and is preferably a non-aqueous electrolyte containing a non-aqueous solvent and an electrolyte salt dissolved in the non-aqueous solvent. As the non-aqueous solvent, for example, esters, ethers, nitriles, amides, a mixed solvent of two or more thereof, and the like are used. The non-aqueous solvent may contain a halogen-substituted product in which at least some hydrogen in a solvent described above is substituted with a halogen atom such as fluorine. Examples of the electrolyte salt include lithium salts such as LiPF₆. Note that the electrolyte is not limited to a liquid electrolyte, and may be a solid electrolyte in which a gel polymer or the like is used.

The case body 16 is, for example, a bottomed cylindrical metal container. A gasket 28 is provided between the case body 16 and the sealing assembly 17 to ensure the sealability inside the battery. The case body 16 has a projecting portion 22 in which, for example, a part of the side part of the case body 16 protrudes inward to support the sealing assembly 17. The projecting portion 22 is preferably formed in an annular shape along a circumferential direction of the case body 16, and supports the sealing assembly 17 on an upper surface thereof.

The sealing assembly 17 has a structure in which a filter 23, a lower vent member 24, an insulating member 25, an upper vent member 26, and a cap 27 are sequentially stacked from the electrode assembly 14. Each member included in the sealing assembly 17 has, for example, a disk shape or a ring shape, and the members excluding the insulating member 25 are electrically connected to each other. The lower vent member 24 and the upper vent member 26 are connected to each other at their central parts, and the insulating member 25 is interposed between the circumferential parts of the lower vent member 24 and the upper vent member 26. When the internal pressure of the secondary battery 10 increases due to heat generated by an internal short circuit or the like, for example, the lower vent member 24 deforms so as to push the upper vent member 26 up toward the cap 27 side and breaks, and thus the current pathway between the lower vent member 24 and the upper vent member 26 is cut off. When the internal pressure is further increased, the upper vent member 26 is broken, and gas is discharged through the opening of the cap 27.

In the secondary battery 10 illustrated in FIG. 1, a positive electrode lead 20 attached to the positive electrode 11 extends to the sealing assembly 17 side through a through hole of the insulating plate 18, and a negative electrode lead 21 attached to the negative electrode 12 extends to the bottom side of the case body 16 through the outside of the insulating plate 19. The positive electrode lead 20 is connected to the lower surface of the filter 23, which is the bottom plate of the sealing assembly 17, by welding or the like, and the cap 27, which is electrically connected to the filter 23 and is the top plate of the sealing assembly 17, serves as a positive electrode terminal. The negative electrode lead 21 is connected to a bottom inner surface of the case body 16 by welding or the like, and the case body 16 becomes a negative electrode terminal.

Hereinafter, the positive electrode 11, the negative electrode 12, and the separator 13 will be described in detail.

### [Positive Electrode]

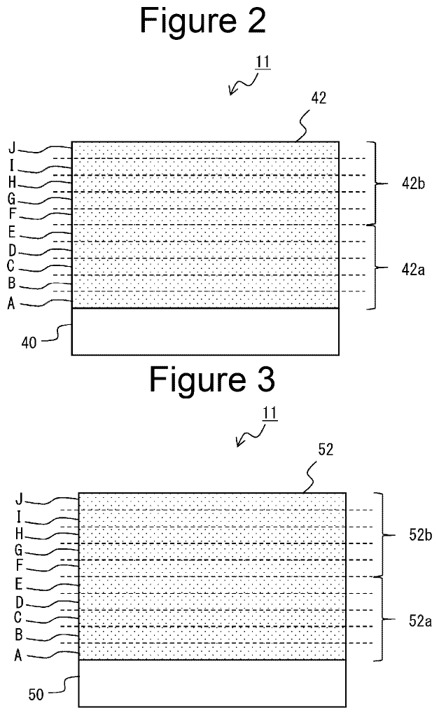

FIG. 2 is a schematic cross-sectional view of a positive electrode as an example of an embodiment. The positive electrode 11 includes a positive electrode current collector 40 and a positive electrode mixture layer 42 provided on the positive electrode current collector. As the positive electrode current collector 40, a foil of a metal stable in a potential range of the positive electrode 11, such as aluminum, a film in which the metal is disposed on a surface layer, or the like can be used. The positive electrode mixture layer 42 contains a positive electrode active material and a binder. The positive electrode mixture layer 42 preferably further contains a conductive agent. The binder includes a polymer binder having a three-dimensional network structure.

The positive electrode 11 can be manufactured, for example, by applying a positive electrode mixture slurry containing a positive electrode active material, a binder, a conductive agent, and the like onto the positive electrode current collector 40 and drying the positive electrode mixture slurry to form a positive electrode mixture layer 42, and then rolling the positive electrode mixture layer 42 by a rolling roller or the like. Note that a method for manufacturing the positive electrode mixture layer 42 will be described in detail.

The positive electrode mixture layer 42 illustrated in FIG. 2 is divided into two in a thickness direction, and a lower half on a side of the positive electrode current collector 40 is defined as a first region 42a, and an upper half on a surface side of the positive electrode mixture layer 42 is defined as a second region 42b. In the present embodiment, the first region 42a contains more of the polymer binder having a three-dimensional network structure than the second region 42b. As described above, since the first region 42a contains more of the polymer binder having a three-dimensional network structure than the second region 42b, it is possible to suppress an increase in direct current resistance due to repetition of charging and discharging of the battery. Although the mechanism of exerting the effect is not sufficiently clear, the following is presumed.

It is presumed that, since the first region 42a contains more of the polymer binder having a three-dimensional network structure, the binding property between the positive electrode active materials or the binding property with the conductive agent, and further the binding property between the positive electrode mixture layer 42 and the positive electrode current collector 40 are enhanced, and thus, a conductive path of the first region 42a and a conductive path between the first region 42a and the positive electrode current collector 40 are hardly cut even when the positive electrode mixture layer 42 expands and contracts due to repetition of charging and discharging of the battery. As a result, it is considered that an increase in direct current resistance due to repetition of charging and discharging of the battery is suppressed.

The three-dimensional network structure means a structure in which a linear polymer three-dimensionally spreads in a network shape by chemical bonding such as a crosslinking point, and does not mean a structure in which fibers of a binder physically fuse to three-dimensionally spread in a network shape. The polymer having a three-dimensional network structure has at least one chemical bonding point such as a crosslinking point in the linear polymer. However, a structure having a chemical bonding point such as a crosslinking point only at a terminal portion of the linear polymer is not a polymer having a three-dimensional network structure. The polymer binder having a three-dimensional network structure can be formed, for example, by crosslinking a polymer that functions as a binder. For the formation of crosslinking, a known method by addition of a crosslinking agent, heating, irradiation with ultraviolet rays or electron beams, or the like can be used. Among them, from the viewpoint of being electrochemically stable at a positive electrode potential, the polymer binder having a three-dimensional network structure preferably contains a fluorine-containing polymer, and the fluorine-containing polymer is preferably crosslinked. That is, it is preferable that a fluorine-containing polymer having a binding force is crosslinked to form a three-dimensional network structure.

The fluorine-containing polymer may contain at least one selected from the group consisting of a unit derived from vinylidene fluoride (VDF), a unit derived from propylene hexafluoride (HFP), and a unit derived from ethylene tetrafluoride (TFE). In this case, the fluorine-containing polymer itself has excellent binding properties. Among them, from the viewpoint of electrochemical stability and the like, the fluorine-containing polymer preferably contains at least a unit derived from VDF. The fluorine-containing polymer preferably contains at least one selected from the group consisting of a copolymer containing units derived from polyvinylidene fluoride (PVDF) and vinylidene fluoride (VDF). The copolymer may be a block copolymer or a random copolymer.

The fluorine-containing polymer may be crosslinked by a crosslinkable monomer (crosslinking agent). For example, the fluorine-containing polymer may undergo a dehydration condensation reaction with the crosslinkable monomer to form an amide bond or an ester bond, and the fluorine-containing polymer may be crosslinked via the crosslinkable monomer. The crosslinkable monomer may have a functional group (for example, a hydroxy group, a carboxy group, an amino group, or the like) that contributes to the condensation reaction. Specific examples of the crosslinkable monomer include trimethylhexamethylenediamine, benzoyl peroxide, dicumyl peroxide, bisphenol A, hexamethylenediamine, ethylenediamine, isopropylethylenediamine, naphthalenediamine, 2,4,4-trimethyl-1, and 6-hexanediamine. The fluorine-containing polymer may have a functional group (for example, a hydroxy group, a carboxy group, an amino group, or the like) that contributes to the dehydration condensation reaction with the crosslinkable monomer, or the functional group may be introduced into the fluorine-containing polymer. For example, a fluorine-containing polymer into which a carboxy group is introduced and a crosslinkable monomer having two amino groups may be subjected to a dehydration condensation reaction, and the fluorine-containing polymers may be crosslinked via the crosslinkable monomer by an amide bond.

An average molecular weight of the polymer binder having a three-dimensional network structure is, for example, greater than or equal to 100,000 and less than or equal to 2,000,000. Note that the average molecular weight is a number average molecular weight (a value in terms of polystyrene) obtained by gel permeation chromatography (GPC).

A content of the polymer binder having a three-dimensional network structure contained in the second region 42b may be less than a content of the polymer binder having a three-dimensional network structure contained in the first region 42a, and it is preferable that the polymer binder having a three-dimensional network structure is not contained in the second region 42b. The second region 42b preferably contains a binder other than the polymer binder having a three-dimensional network structure instead of the polymer binder having a three-dimensional network structure. Therefore, an electrolytic solution easily permeates through a surface of the positive electrode mixture layer 42, which makes it possible to further suppress an increase in direct current resistance due to repetition of charging and discharging of the battery.

A content of the binder other than the polymer binder having a three-dimensional network structure contained in the second region 42b is, for example, in a range of greater than or equal to 30 mass % and less than or equal to 70 mass % with respect to the total mass of the binder contained in the positive electrode mixture layer 42. Examples of the binder other than the polymer binder having a three-dimensional network structure include a polymer binder having no three-dimensional network structure. The polymer having no three-dimensional network structure means a linear polymer having a structure having no scientific bond such as a crosslinking point, and a polymer having a structure having a chemical bonding point such as a crosslinking point only at a terminal portion of a linear polymer. The polymer binder having no three-dimensional network structure is, for example, a fluororesin, a polyolefin resin, an acrylic resin, or the like, and specific examples thereof include polytetrafluoroethylene (PTFE), polyvinylidene fluoride (PVDF), polyethylene, polypropylene, polyacrylic acid, methyl polyacrylate, and an ethylene-acrylic acid copolymer.

A content of the polymer binder having a three-dimensional network structure contained in the first region 42a is, for example, in a range of greater than or equal to 30 mass % and less than or equal to 70 mass % with respect to the total mass of the binder contained in the positive electrode mixture layer 42. Note that the first region 42a may also contain a binder other than the polymer binder having a three-dimensional network structure.

In the present embodiment, it is preferable that the binders contained in the first region 42a and the second region 42b have a PVDF skeleton, and a generation initiation temperature (T1) of a peak observed from a temperature-chromatogram curve for a mass-to-charge ratio (m/z)=132 obtained by evolved gas analysis-mass spectrometry (EGA-MS) for the first region 42a is higher than a generation initiation temperature (T2) of a peak observed from a temperature-chromatogram curve for a mass-to-charge ratio (m/z)=132 obtained by evolved gas analysis-mass spectrometry (EGA-MS method) for the second region 42b. Therefore, an increase in direct current resistance due to repetition of charging and discharging of the battery is further suppressed.

The peak observed from the temperature-chromatogram curve for the mass-to-charge ratio (n/z)=132 is a peak derived from 1,3,5-trifluorobenzene, which is a decomposition product generated by thermal decomposition of a binder having a PVDF skeleton. Then, it can be said that as the generation initiation temperature of the peak (that is, the temperature at which the peak rises) is higher, for example, a polymer binder having a PVDF skeleton that is hardly thermally decomposed and has high cohesiveness is present in the region. Therefore, in the present embodiment, since T1 is greater than T2, a polymer binder having a highly cohesive PVDF skeleton is present in the first region 42a. Therefore, it is presumed that the binding property between the positive electrode active materials or the binding property with the conductive agent, and further the binding property between the positive electrode mixture layer 42 and the positive electrode current collector 40 are enhanced, and thus, the conductive path of the first region 42a and the conductive path between the first region 42a and the positive electrode current collector 40 are hardly cut even when the positive electrode mixture layer 42 expands and contracts due to repetition of charging and discharging of the battery. As a result, it is considered that an increase in direct current resistance due to repetition of charging and discharging of the battery is suppressed. Note that a production example of the positive electrode mixture layer 42 in which T1 is greater than T2 will be described below.

For the evolved gas analysis-mass spectrometry (EGA-MS), a gas chromatograph (GC) measuring apparatus equipped with a heating furnace (pyrolzer) directly connected by an inert capillary tube and a mass spectrometer was used.
GC measuring apparatus: product name: HP6890, manufactured by Agilent Technologies, Inc.
Heating furnace: product name: PY2020D, manufactured by Frontier Laboratories, Inc.
Mass spectrometer: product name: HP-5973, manufactured by Hewlett-Packard Company
Inert capillary tube: product name: Ultra Alloy DTM, length 2.5 m×inner diameter 0.15 mm

In a gas chromatograph (GC) measuring apparatus, 2 mg of a sample is placed, and the temperature is raised from higher than or equal to 60° C. and lower than or equal to 500° C. at a temperature raising rate of 10° C./min in a helium atmosphere (flow rate 20 ml/min in a standard state) to thermally decompose the sample. Mass spectrometry of a decomposition product of the sample contained in the generated gas is performed to obtain a temperature-chromatogram curve. In the obtained temperature-chromatogram curve, the peak observed on the temperature-chromatogram curve for a mass-to-charge ratio (m/z)=132 derived from the decomposition product of the sample is defined as a peak derived from 1,3,5-trifluorobenzene, which is a decomposition product of a polymer binder having a PVDF skeleton. The sample used for the measurement is a sample scraped from the first region 42a of the positive electrode mixture layer 42 or a sample scraped from the second region 42b.

The positive electrode mixture layer 42 illustrated in FIG. 2 is divided into ten in the thickness direction, and regions obtained by dividing the positive electrode mixture layer into ten are defined as an A region, a B region, a C region, a D region, an E region, an F region, a G region, an H region, an I region, and a J region in this order from the positive electrode current collector 40 side.

In the present embodiment, the binders contained in the A to J regions have a PVDF skeleton, and a ratio (W/V) of the highest proportion (W) of an element F among the proportions of the elements F derived from the binders contained in the respective regions of the D region, the E region, and the F region to the highest proportion (V) of an element F among the proportions of the elements F derived from the binders contained in the respective regions of the A region, the B region, and the C region is preferably less than 1.3. When the ratio W/V is less than 1.3, the content of the binders in the regions A to C close to the positive electrode current collector 40 becomes large as compared with the case where the ratio W/V is greater than or equal to 1.3, such that the adhesive force between the positive electrode current collector 40 and the positive electrode mixture layer 42 becomes strong. As a result, even when the positive electrode mixture layer 42 expands and contracts due to repetition of charging and discharging of the battery, the positive electrode mixture layer 42 is suppressed from being peeled off from the positive electrode current collector 40, and thus it is considered that an increase in direct current resistance is further suppressed.

Here, the proportion of the element F derived from the binder contained in each region means a proportion (atom %) of the amount of the element F derived from the binder contained in each region with respect to the total amount of the elements F derived from the binders contained in the entire regions (that is, the A region to the J region). Such a proportion of the element F is analyzed with an electron probe microanalyzer (EPMA) along the surface side of the positive electrode mixture layer 42 from the positive electrode current collector 40 side with respect to the cross section of the positive electrode mixture layer 42, and is calculated by measuring the amount of the element F derived from the binder in each region. As the electron probe microanalyzer (EPMA), for example, EMPA-1600 (product name) manufactured by Shimadzu Corporation is used.

### <Measurement Conditions of EPMA>

Acceleration voltage: 15 kV
Beam diameter: 2 μm
Integration time: 1 second
Step interval: 2 μm
Sample current: 0.15 μA

Examples of the positive electrode active material contained in the positive electrode mixture layer 42 include lithium composite oxides containing transition metal elements such as Co, Mn, and Ni. The lithium composite oxide may contain, for example, Ni, Co, Mn, Al, Zr, B, Mg, Sc, Y, Ti, Fe, Cu, Zn, Cr, Pb, Sn, Na, K, Ba, Sr, Ca, W, Mo, Nb, Si, or the like. These lithium composite oxides may be used alone or as a mixture of a plurality of kinds.

In addition, from the viewpoint that a high capacity of the secondary battery can be achieved, it is preferable that the positive electrode active material contains a lithium composite oxide represented by General Formula: LiₐNiₓCo_{y}M_{1-x-y}O₂ (where a, x, and y satisfy 0.97≤a≤1.2, 0.8≤x≤1.0, and 0≤y≤0.2, respectively, and M includes at least one selected from the group consisting of Mn, Al, B, W, Sr, Mg, Mo, Nb, Ti, Si, and Zr), and in the formula, it is more preferable that y=0. Note that, the lithium composite oxide represented by the general formula described above is used, and therefore, in general, direct current resistance due to repetition of charging and discharging of the battery is likely to increase. However, in the present embodiment, as described above, since the effect of suppressing the increase in direct current resistance due to repetition of charging and discharging of the battery is exhibited, even when the lithium composite oxide represented by the general formula described above is used, the increase in direct current resistance due to repetition of charging and discharging of the battery can be suppressed.

Examples of the conductive agent contained in the positive electrode mixture layer 42 include a carbon-based material such as amorphous carbon (for example, carbon black, acetylene black, Ketjenblack, or the like), graphite, or carbon nanotubes, and metal particles.

An example of a method for manufacturing the positive electrode mixture layer 42 will be described. For example, a first positive electrode mixture slurry is prepared by mixing a positive electrode active material, a conductive agent, a polymer binder having a three-dimensional network structure, and the like together with a solvent. In addition to the slurry, a positive electrode active material, a conductive agent, and a polymer binder having no three-dimensional network structure or a polymer binder having a three-dimensional network structure smaller than that of the first positive electrode mixture slurry are mixed together with a solvent (that is, a dispersant) to prepare a second positive electrode mixture slurry. Then, the first positive electrode mixture slurry is applied onto the positive electrode current collector 40 at a predetermined thickness, and then the second positive electrode mixture slurry is applied onto the first positive electrode mixture slurry at a predetermined thickness and dried to form the positive electrode mixture layer 42.

For example, T1 described above can be set to be higher than T2 by using a polymer binder having a three-dimensional network structure and a PVFD skeleton for the first positive electrode mixture slurry and using a polymer binder having no three-dimensional network structure and having a PVFD skeleton for the second positive electrode mixture slurry. In addition, for example, when using a polymer binder having a three-dimensional network structure and a PVFD skeleton for the first positive electrode mixture slurry and the second positive electrode mixture slurry. T1 described above can be set to be higher than T2 by using a polymer binder having a higher molecular weight for the first positive electrode mixture slurry than the polymer binder used for the second positive electrode mixture slurry.

As another example of the method for producing the positive electrode mixture layer 42, the first positive electrode mixture slurry may be applied onto the positive electrode current collector 40 at a predetermined thickness and dried, and then the second positive electrode mixture slurry may be applied onto the dried coating film at a predetermined thickness and dried. However, it is easier to adjust the above-described W/V to less than 1.3 by simultaneous drying of a slurry in which the first positive electrode mixture slurry is applied onto the positive electrode current collector 40 at a predetermined thickness, the second positive electrode mixture slurry is applied onto the first positive electrode mixture slurry at a predetermined thickness, and the slurry is dried rather than such sequential drying of the slurry.

A content of the positive electrode active material contained in the positive electrode mixture layer 42 is preferably, for example, greater than or equal to 90 mass % with respect to the total mass of the positive electrode mixture layer 42. A content of the conductive agent contained in the positive electrode mixture layer 42 is preferably greater than or equal to 1 mass % with respect to the total mass of the positive electrode mixture layer 42. In addition, a content of the binder contained in the positive electrode mixture layer 42 is preferably greater than or equal to 0.5 mass % with respect to the total mass of the positive electrode mixture layer 42.

FIG. 3 is a cross-sectional view of a positive electrode as another example of the embodiment. The positive electrode 11 includes a positive electrode current collector 50 and a positive electrode mixture layer 52 provided on the positive electrode current collector 50. As the positive electrode current collector 50, a foil of a metal stable in a potential range of the positive electrode 11, such as aluminum, a film in which the metal is disposed on a surface layer, or the like can be used. The positive electrode mixture layer 52 contains a positive electrode active material and a binder. The positive electrode mixture layer 42 preferably further contains a conductive agent.

The positive electrode 11 can be manufactured, for example, by applying a positive electrode mixture slurry containing a positive electrode active material, a binder, a conductive agent, and the like onto the positive electrode current collector 50 and drying the positive electrode mixture slurry to form a positive electrode mixture layer 52, and then rolling the positive electrode mixture layer 52 by a rolling roller or the like. Note that a method for producing the positive electrode mixture layer 52 will be described in detail.

The positive electrode mixture layer 52 illustrated in FIG. 3 is divided into two in a thickness direction, a lower half on a side of the positive electrode current collector 50 is defined as a first region 52a, and an upper half on a surface side of the positive electrode mixture layer 52 is defined as a second region 52b. In the present embodiment, the binders contained in the first region 52a and the second region 52b include a binder having a PVDF skeleton, and a generation initiation temperature (T1) of a peak observed from a temperature-chromatogram curve for a mass-to-charge ratio (n/z)=132 obtained by evolved gas analysis-mass spectrometry (EGA-MS) for the first region 52a is higher than a generation initiation temperature (T2) of a peak observed from a temperature-chromatogram curve for a mass-to-charge ratio (m/z)=132 obtained by evolved gas analysis-mass spectrometry (EGA-MS method) for the second region 52b. Therefore, an increase in direct current resistance due to repetition of charging and discharging of the battery is further suppressed. Although the mechanism of exerting the effect is not sufficiently clear, the following is presumed.

The peak observed from the temperature-chromatogram curve for the mass-to-charge ratio (m/z)=132 is a peak derived from 1,3,5-trifluorobenzene, which is a decomposition product generated by thermal decomposition of a binder having a PVDF skeleton. Then, it is shown that as the generation initiation temperature of the peak (that is, the temperature at which the peak rises) is higher, for example, a binder having a PVDF skeleton that is hardly thermally decomposed and has high cohesiveness is present in the region. Therefore, in the present embodiment, it can be said that since T1 is greater than T2, a binder having a highly cohesive PVDF skeleton is present in the first region 52a. Therefore, it is presumed that the binding property between the positive electrode active materials or the binding property with the conductive agent, and further the binding property between the positive electrode mixture layer 52 and the positive electrode current collector 50 are enhanced, and thus, a conductive path of the first region 52a and a conductive path between the first region 52a and the positive electrode current collector 50 are hardly cut even when the positive electrode mixture layer 52 expands and contracts due to repetition of charging and discharging of the battery. As a result, it is considered that an increase in direct current resistance due to repetition of charging and discharging of the battery is suppressed. The method and conditions of the evolved gas analysis-mass spectrometry (EGA-MS) are as described above, and thus are omitted. Note that a production example of the positive electrode mixture layer 52 in which T1 is greater than T2 will be described below.

The binder having a PVDF skeleton is, for example, a copolymer containing units derived from polyvinylidene fluoride (PVDF) and vinylidene fluoride (VDF). The copolymer may be a block copolymer or a random copolymer. The binder having a PVDF skeleton may have a three-dimensional network structure. The three-dimensional network structure is as described above, and for example, a binder having a PVDF skeleton may be crosslinked by a known method such as addition of a crosslinking agent, heating, or irradiation with ultraviolet rays or electron beams to form a three-dimensional network structure. The crosslinking agent (crosslinkable monomer) is as described above.

An average molecular weight of the binder having a PVDF skeleton is, for example, greater than or equal to 100,000 and less than or equal to 2,500,000. Note that the average molecular weight is a number average molecular weight (a value in terms of polystyrene) obtained by gel permeation chromatography (GPC).

The positive electrode mixture layer 52 may contain a binder other than the binder having a PVDF skeleton. Examples of the binder other than the binder having a PVDF skeleton include polytetrafluoroethylene (PTFE), polyethylene, polypropylene, polyacrylic acid, polymethyl acrylate, and an ethylene-acrylic acid copolymer.

The positive electrode mixture layer 52 illustrated in FIG. 3 is divided into ten in the thickness direction, and regions obtained by dividing the positive electrode mixture layer into ten are defined as an A region, a B region, a C region, a D region, an E region, an F region, a G region, an H region, an I region, and a J region in this order from the positive electrode current collector 50.

In the present embodiment, the binders contained in the A to J regions include a binder having a PVDF skeleton, and a ratio (W/V) of the highest proportion (W) of an element F among the proportions of the elements F derived from the binders contained in the respective regions of the D region, the E region, and the F region to the highest ratio (V) of an element F among the proportions of the elements F derived from the binders contained in the respective regions of the A region, the B region, and the C region is preferably less than 1.3. When the ratio W/V is less than 1.3, the content of the binders in the regions A to C close to the positive electrode current collector 50 becomes large as compared with the case where the ratio W/V is greater than or equal to 1.3, such that the adhesive force between the positive electrode current collector 50 and the positive electrode mixture layer 52 becomes strong. As a result, even when the positive electrode mixture layer 52 expands and contracts due to repetition of charging and discharging of the battery, the positive electrode mixture layer 52 is suppressed from being peeled off from the positive electrode current collector 50, and thus it is considered that an increase in direct current resistance is further suppressed. The method for measuring the proportion of the element F derived from the binder contained in each region is as described above, and thus is omitted.

Examples of the positive electrode active material contained in the positive electrode mixture layer 52 include lithium transition metal oxides containing transition metal elements such as Co, Mn, and Ni. The lithium composite oxide may contain, for example, Ni, Co, Mn, Al, Zr, B, Mg, Sc, Y, Ti, Fe, Cu, Zn, Cr, Pb, Sn, Na, K, Ba, Sr, Ca, W, Mo, Nb, Si, or the like. These lithium composite oxides may be used alone or as a mixture of a plurality of kinds.

In addition, from the viewpoint that a high capacity of the secondary battery can be achieved, it is preferable that the positive electrode active material contains a lithium composite oxide represented by General Formula: LiₐNiₓCo_{y}M_{1-x-y}O₂ (where a, x, and y satisfy 0.97≤a≤1.2, 0.8≤x≤1.0, and 0≤y≤0.2, respectively, and M includes at least one selected from the group consisting of Mn, Al, B, W, Sr, Mg, Mo, Nb, Ti, Si, and Zr), and in the formula, it is more preferable that y=0. Note that, the lithium composite oxide represented by the general formula described above is used, and therefore, in general, direct current resistance due to repetition of charging and discharging of the battery is likely to increase. However, in the present embodiment, as described above, since the effect of suppressing the increase in direct current resistance due to repetition of charging and discharging of the battery is exhibited, even when the lithium composite oxide represented by the general formula described above is used, the increase in direct current resistance due to repetition of charging and discharging of the battery can be suppressed.

Examples of the conductive agent contained in the positive electrode mixture layer 52 include a carbon-based material such as amorphous carbon (for example, carbon black, acetylene black, Ketjenblack, or the like), graphite, or carbon nanotubes, and metal particles.

An example of a method for producing the positive electrode mixture layer 52 will be described. For example, a first positive electrode mixture slurry is prepared by mixing a positive electrode active material, a conductive agent, a binder having a PVDF skeleton, and the like together with a solvent. In addition to the slurry, a second positive electrode mixture slurry is prepared by mixing a positive electrode active material, a conductive agent, a binder having a PVDF skeleton, and the like together with a solvent (that is, a dispersant). Then, the first positive electrode mixture slurry is applied onto the positive electrode current collector 50 at a predetermined thickness, and then the second positive electrode mixture slurry is applied onto the first positive electrode mixture slurry at a predetermined thickness and dried to form the positive electrode mixture layer 52.

Here, an example of a method for adjusting T1 and T2 described above will be described. For example, T1 described above can be set to be higher than T2 by using a binder having a three-dimensional network structure and a PVFD skeleton for the first positive electrode mixture slurry and using a binder having no three-dimensional network structure and having a PVFD skeleton for the second positive electrode mixture slurry. In addition, for example, T1 described above can be set to be higher than T2 by using a binder having a PVDF skeleton having a higher molecular weight for the first positive electrode mixture slurry than a binder having a PVDF skeleton used for the second positive electrode mixture slurry.

As another example of the method for producing the positive electrode mixture layer 52, the first positive electrode mixture slurry may be applied onto the positive electrode current collector 50 at a predetermined thickness and dried, and then the second positive electrode mixture slurry may be applied onto the dried coating film at a predetermined thickness and dried. However, it is easier to adjust the above-described W/V to less than 1.3 by simultaneous drying of a slurry in which the first positive electrode mixture slurry is applied onto the positive electrode current collector 50 at a predetermined thickness, the second positive electrode mixture slurry is applied onto the first positive electrode mixture slurry at a predetermined thickness, and the slurry is dried rather than such sequential drying of the slurry.

A content of the positive electrode active material contained in the positive electrode mixture layer 52 is preferably, for example, greater than or equal to 90 mass % with respect to the total mass of the positive electrode mixture layer 52. A content of the conductive agent contained in the positive electrode mixture layer 52 is preferably, for example, greater than or equal to 1 mass % with respect to the total mass of the positive electrode mixture layer 52. In addition, a content of the binder contained in the positive electrode mixture layer 52 is preferably greater than or equal to 0.5 mass % with respect to the total mass of the positive electrode mixture layer 42.

### [Negative Electrode]

The negative electrode 12 includes a negative electrode current collector and a negative electrode mixture layer provided on the negative electrode current collector. Examples of the negative electrode current collector include a foil of a metal stable in a potential range of the negative electrode, such as copper, and a film in which the metal is disposed on a surface layer.

It is preferable that the negative electrode mixture layer contains a negative electrode active material and further contains a binder or a conductive agent. The negative electrode 12 can be manufactured by preparing a negative electrode mixture slurry containing a negative electrode active material, a binder, and the like, applying the negative electrode mixture slurry onto the negative electrode current collector, performing drying to form the negative electrode mixture layer, and rolling the negative electrode mixture layer.

The negative electrode active material is not particularly limited as long as it is a material capable of occluding and releasing lithium ions, and examples thereof include metal lithium, lithium alloys such as a lithium-aluminum alloy, a lithium-lead alloy, a lithium-silicon alloy, and a lithium-tin alloy, carbon materials such as graphite, coke, and organic substance fired bodies, and metal oxides such as SnO₂, SnO, and TiO₂. These materials may be used alone or in combination of two or more thereof.

Examples of the binder include fluororesins such as polytetrafluoroethylene (PTFE) and polyvinylidene fluoride (PVdF), polyacrylonitrile (PAN), polyimide, acrylic resins, polyolefins, styrene-butadiene rubber (SBR), cellulose derivatives such as carboxymethyl cellulose (CMC) and its salts, and polyethylene oxide (PEO). Examples of the conductive agent include materials similar to those for the positive electrode 11.

### [Separator]

As the separator 13, for example, a porous sheet having an ion permeation property and an insulation property is used. Specific examples of the porous sheet include fine porous thin films, woven fabrics, and nonwoven fabrics. As a material of the separator, olefin-based resins such as polyethylene and polypropylene, cellulose, and the like are suitable. The separator 13 may be a stacked body having a cellulose fiber layer and a thermoplastic resin fiber layer such as an olefin-based resin. The separator may be a multilayer separator including a polyethylene layer and a polypropylene layer, and a separator may be used that has a surface to which a material such as an aramid-based resin or a ceramic is applied.

### EXAMPLES

Hereinafter, the present disclosure will be further described with reference to Examples. However, the present disclosure is not limited to these Examples.

### Example 1

A positive electrode mixture slurry A was prepared by adding an appropriate amount of N-methyl-2-pyrrolidone to a mixture obtained by mixing a lithium composite oxide represented by LiNi_{0.8}Co_{0.15}Al_{0.05}O₂, a binder P, and a conductive agent at a mass ratio of 100:1:1 and stirring the mixture.

The binder P used in the positive electrode mixture slurry A was prepared as follows. First, a copolymer of vinylidene fluoride and hexafluoropropylene:PVDF-HFP (manufactured by Sigma-Aldrich, average molecular weight Mw: 400,000) and trimethyllhexamethylenediamine (manufactured by Tokyo Chemical Industry Co., Ltd.) as a crosslinking agent were dissolved in methyl isobutyl ketone to obtain a mixed solution. The mixed solution was cast to produce a film (solution casting method). The film was heated at 110° C. to produce a crosslinked fluorine-containing polymer (binder P). The amount of trimethylhexamethylenediamine added was 0.1 parts by mass per 100 parts by mass of PVDF-HFP. The film-like binder P was pulverized into a powder.

The prepared binder P was analyzed by Dynamic Mechanical Analysis (DMA), Differential Scanning Calorimetry (DSC), and Evolved Gas Analysis (EGA). When a storage elastic modulus was confirmed by DMA, it was confirmed that a high storage elastic modulus was obtained by three-dimensional crosslinking. In addition, it was confirmed by DSC that the glass transition temperature Tg of the PVDF polymer was increased. In addition, it was confirmed by EGA that the generation initiation temperature of the peak for m/z=132 was shifted to the high temperature side. It was confirmed from the above analysis that the obtained crosslinked fluorine-containing polymer had a three-dimensional network structure in which a fluorine-containing polymer of PVDF-HFP was crosslinked.

The average molecular weight of the binder P was greater than or equal to 1,000,000. As described above, the average molecular weight is a number average molecular weight obtained by gel permeation chromatography (GPC). The measurement of the average molecular weight is the same as described below.

A positive electrode mixture slurry B was prepared by adding an appropriate amount of N-methyl-2-pyrrolidone to a mixture obtained by mixing a lithium composite oxide represented by LiNi_{0.8}Co_{0.15}Al_{0.05}O₂, a binder Q, and a conductive agent at a mass ratio of 100:1:1 and stirring the mixture.

The binder Q used in the positive electrode mixture slurry B is a copolymer of vinylidene fluoride and hexafluoropropylene:PVDF-HFP (manufactured by Sigma-Aldrich). The average molecular weight of the binder Q was greater than or equal to 400,000.

The positive electrode mixture slurry A was applied onto both surfaces of an aluminum foil having a thickness of 15 μm, the positive electrode mixture slurry B was applied onto the positive electrode mixture slurry A, and then drying was performed, thereby forming a coating film. Thereafter, the coating film was rolled by a rolling roller to manufacture a positive electrode in which a positive electrode mixture layer was formed on both surfaces of a positive electrode current collector. A coating thickness ratio of the positive electrode mixture slurry A to the positive electrode mixture slurry B was set to 50:50, and a basis weight of the positive electrode mixture layer was set to 200 g/m². The basis weights of the positive electrode mixture layers are the same in other Examples and Comparative Examples.

In a case where the positive electrode mixture layer was divided into two in a thickness direction, a lower half on a side of the positive electrode current collector was defined as a first region, and an upper half on a surface side of the positive electrode mixture layer was defined as a second region, a generation initiation temperature (T1) of a peak observed from a temperature-chromatogram curve for a mass-to-charge ratio (m/z)=132 obtained by evolved gas analysis-mass spectrometry (EGA-MS) for the first region was 350° C. In addition, a generation initiation temperature (T2) of a peak observed from a temperature-chromatogram curve for a mass-to-charge ratio (m/z)=132 obtained by evolved gas analysis-mass spectrometry (EGA-MS) for the second region was 280° C. The measurement method of the evolved gas analysis-mass spectrometry is as described above.

In addition, in a case where the positive electrode mixture layer was divided into ten in the thickness direction, and regions obtained by dividing the positive electrode mixture layer into ten were defined as an A region, a B region, a C region, a D region, an E region, an F region, a G region, an H region, an I region, and a J region in this order from the positive electrode current collector, a ratio (W/V) of the highest proportion (W) of an element F among the proportions of the elements F derived from the binders contained in the respective regions of the D region, the E region, and the F region to the highest proportion (V) of an element F among the proportions of the elements F derived from the binders contained in the respective regions of the A region, the B region, and the C region was 1.05. The method for measuring the proportion of the element F derived from the binder in each region is as described above.

Hereinafter, T1, T2, and the ratio W/V will be simply described.

### [Manufacture of Negative Electrode]

Graphite, CMC, and SBR were mixed at a mass ratio of 98:1:1, and the mixture was kneaded with water, thereby preparing a negative electrode mixture slurry. The negative electrode mixture slurry was applied onto both surfaces of a copper foil having a thickness of 8 μm, the coating film was dried, and then the dried coating film was rolled by a rolling roller, thereby manufacturing a negative electrode in which a negative electrode mixture layer was formed on both surfaces of a negative electrode current collector.

### [Preparation of Non-Aqueous Electrolyte]

LiPF₆ was dissolved in a mixed solvent composed of ethylene carbonate (EC) and methylethyl carbonate (MEC) (EC:MEC=1:3 by volume ratio) at a concentration of 1 mol/L. The resulting mixture was used as a non-aqueous electrolyte.

### [Manufacture of Secondary Battery]

(1) A separator (a composite film of polyethylene and polypropylene) was wound between the positive electrode and the negative electrode to manufacture a wound electrode assembly. A lead was attached to each of the positive electrode and the negative electrode.

(2) The electrode assembly was inserted into a case body, the lead of the negative electrode was welded to the bottom of the case body, and the lead of the positive electrode was welded to a sealing assembly.

(3) A non-aqueous electrolyte was injected into the case body, and then an end part of an opening of the case body was caulked with the sealing assembly via a gasket. The battery was used as a secondary battery of Example 1.

### Example 2

A positive electrode was manufactured in the same manner as in Example 1, except that the molecular weight of PVDF-HFP as a raw material of the binder P used in the positive electrode mixture slurry A was changed to 450,000, and the molecular weight of the binder Q used in the positive electrode mixture slurry B was changed to 450,000. The average molecular weight of the binder P used in Example 2 was greater than or equal to 1,000.000, and the average molecular weight of the binder Q was 450,000. In the manufactured positive electrode, T1 was 360° C., T2 was 300° C., and the ratio W/V was 1.03. Then, a secondary battery was manufactured in the same manner as in Example 1, except that the positive electrode was used.

### Example 3

A positive electrode was manufactured in the same manner as in Example 2, except that the positive electrode mixture slurry A was applied onto both surfaces of an aluminum foil having a thickness of 15 μm and dried, and then the positive electrode mixture slurry B was applied onto a coating film of the obtained positive electrode mixture slurry B and dried. In the manufactured positive electrode, T1 was 360° C., T2 was 300° C., and the ratio W/V was 1.35. A secondary battery was manufactured in the same manner as that of Example 1, except that the positive electrode was used.

### Comparative Example 1

The positive electrode mixture slurry A used in Example 2 was applied onto both surfaces an aluminum foil having a thickness of 15 μm and then dried to form a coating film. Thereafter, the coating film was rolled by a rolling roller to manufacture a positive electrode in which a positive electrode mixture layer was formed on both surfaces of a positive electrode current collector. In the manufactured positive electrode, T1 was 360° C., T2 was 360° C., and the ratio W/V was 1.05. A secondary battery was manufactured in the same manner as that of Example 1, except that the positive electrode was used.

### Comparative Example 2

The positive electrode mixture slurry B used in Example 2 was applied onto both surfaces an aluminum foil having a thickness of 15 μm and then dried to form a coating film. Thereafter, the coating film was rolled by a rolling roller to manufacture a positive electrode in which a positive electrode mixture layer was formed on both surfaces of a positive electrode current collector. In the manufactured positive electrode, T1 was 300° C. T2 was 300° C., and the ratio W/V was 1.04. A secondary battery was manufactured in the same manner as that of Example 1, except that the positive electrode was used.

### Comparative Example 3

The positive electrode mixture slurry B used in Example 2 was applied onto both surfaces of an aluminum foil having a thickness of 15 μm, the positive electrode mixture slurry A used in Example 2 was applied onto the positive electrode mixture slurry B, and then drying was performed, thereby forming a coating film. Thereafter, the coating film was rolled by a rolling roller to manufacture a positive electrode in which a positive electrode mixture layer was formed on both surfaces of a positive electrode current collector. A coating thickness ratio of the positive electrode mixture slurry A to the positive electrode mixture slurry B was set to 50:50.

In the manufactured positive electrode, T1 was 300° C., T2 was 360° C., and the ratio W/V was 1.05. A secondary battery was manufactured in the same manner as that of Example 1, except that the positive electrode was used.

### [Measurement of Direct Current Resistance]

In an environment of 25° C., the secondary battery of each of Examples and each of Comparative Examples was charged to SOC 50% at a constant current of 0.5 C. The voltage at this time was defined as V0. Next, discharge was performed at a constant current of 0.5 C for 10 seconds. The voltage at this time was defined as V1. Then, direct current resistance (DCR) was obtained from the following equation. This is referred to as an initial direct current resistance.

$$DCR = ( V 0 - V 1 ) / 0.5 It$$

Next, the secondary battery of each of Examples and each of Comparative Examples was subjected to constant voltage charge at a constant current of 0.5 C until the voltage reached 4.3 V, and then subjected to constant voltage charge until the current reached 0.05 C. Thereafter, the battery was subjected to constant current discharge at a constant current of 0.5 C until the battery voltage reached 2.5 V. The charge and discharge was defined as one cycle, and 100 cycles were performed. Then, in an environment of 25° C., the secondary battery of each of Examples and each of Comparative Examples was subjected to constant current discharge at a constant current of 0.5 C until the voltage reached 3.0 V, and then the direct current resistance was determined by the same method as described above. This is defined as the direct current resistance after the charge and discharge cycle.

The initial direct current resistance and the direct current resistance after the charge and discharge cycle were applied to the following equation to determine a direct current resistance increase rate.

$$Direct current resistance increase rate =$$

$$( Direct current resistance after charge and discharge cycle /$$

$$Initial direct current resistance ) \times 100$$

In Table 1, the direct current resistance increase rates of the other Examples and Comparative Examples with respect to the standard (100%) of the resistance increase rate of Comparative Example 1 as relative values are shown.

TABLE 1

| | | | | Comparative | Comparative | Comparative |
|---|---|---|---|---|---|---|
| | Example 1 | Example 2 | Example 3 | Example 1 | Example 2 | Example 3 |
| Binder of upper | PVDF-HFP | PVDF-HFP | PVDF-HFP | Binder having | PVDF-HFP | Binder having |
| positive | (400000) | (450000) | (450000) | three- | (450000) | three- |
| electrode | | | | dimensional | | dimensional |
| mixture slurry | | | | network | | network |
| (molecular | | | | structure | | structure |
| weight) | | | | (greater than of | | (greater than of |
| | | | | equal to | | equal to |
| | | | | 1,500,000) | | 1,500,000) |
| Binder of lower | Binder having | Binder having | Binder having | | | PVDF-HFP |
| positive | three- | three- | three- | | | (450000) |
| electrode | dimensional | dimensional | dimensional | | | |
| mixture slurry | network | network | network | | | |
| (molecular | structure | structure | structure | | | |
| weight) | (greater than or | (greater than or | (greater than | | | |
| | equal to | equal to | or equal to | | | |
| | 1,500,000) | 1,500,000) | 1,500,000) | | | |
| T2/° C. | 280 | 300 | 300 | 360 | 300 | 360 |
| T1/° C. | 350 | 360 | 360 | 360 | 300 | 300 |
| Positive | Simultaneous | Simultaneous | Sequential | — | — | Simultaneous |
| electrode | drying | drying | drying | | | drying |
| mixture layer | | | | | | |
| production | | | | | | |
| method | | | | | | |
| Ratio W/V | 1.05 | 1.03 | 1.35 | (1.05) | (1.04) | 1.05 |
| Direct current | 98% | 97% | 99% | 100% | 102% | 102% |
| resistance | | | | | | |
| increase rate | | | | | | |

As shown in Table 1, all of Examples 1 to 3 had a lower direct current resistance increase rate than Comparative Examples 1 to 3. Therefore, in a case where the positive electrode mixture layer is divided into two in the thickness direction, the lower half on the side of the positive electrode current collector is defined as a first region, and the upper half oil the surface side of the positive electrode mixture layer is defined as a second region, the first region contains more of the polymer binder having a three-dimensional network structures than the second region, such that it is possible to suppress an increase in direct current resistance when the battery is repeatedly charged and discharged. In addition, when comparing Examples 2 and 3 using the same positive electrode mixture slurry, Example 2 showed a lower direct current resistance increase rate than Example 3. Therefore, in a case where the positive electrode mixture layer was divided into ten in the thickness direction, and regions obtained by dividing the positive electrode mixture layer into ten were defined as an A region, a B region, a C region, a D region, an E region, an F region, a G region, an H region, an I region, and a J region in this order from the positive electrode current collector, a positive electrode in which a ratio (W/V) of the highest proportion (W) of an element F among the proportions of the elements F derived from the binders contained in the respective regions of the D region, the E region, and the F region to the highest proportion (V) of an element F among the proportions of the elements F derived from the binders contained in the respective regions of the A region, the B region, and the C region is greater than 1.35 is used, such that it is possible to suppress an increase in direct current resistance when the battery is repeatedly charged and discharged.

### REFERENCE SIGNS LIST

10 Secondary battery
11 Positive electrode
12 Negative electrode
13 Separator
14 Electrode assembly
15 Battery case
16 Case body
17 Sealing assembly
18, 19 Insulating plate
20 Positive electrode lead
21 Negative electrode lead
22 Projecting portion
23 Filter
24 Lower vent member
25 Insulating member
26 Upper vent member
27 Cap
28 Gasket
40, 50 Positive electrode current collector
42, 52 Positive electrode mixture layer
42a, 52a First region
42b, 52b Second region

1. A positive electrode for a secondary battery, comprising: a positive electrode current collector; and a positive electrode mixture layer that is provided on the positive electrode current collector and contains a positive electrode active material and a binder, wherein the binder includes a polymer binder having a three-dimensional network structure, and
in a case where the positive electrode mixture layer is divided into two in a thickness direction, a lower half on a side of the positive electrode current collector is defined as a first region, and an upper half on a surface side of the positive electrode mixture layer is defined as a second region, the first region contains more of the polymer binder having a three-dimensional network structure than the second region.

2. The positive electrode for a secondary battery according to claim 1, wherein the second region does not contain the polymer binder having a three-dimensional network structure.

3. The positive electrode for a secondary battery according to claim 1,
wherein the binders contained in the first region and the second region have a PVDF skeleton, and
a generation initiation temperature of a peak observed from a temperature-chromatogram curve for a mass-to-charge ratio (m/z)=132 obtained by evolved gas analysis-mass spectrometry (EGA-MS) for the first region is higher than a generation initiation temperature of a peak observed from a temperature-chromatogram curve for a mass-to-charge ratio (m/z)=132 obtained by evolved gas analysis-mass spectrometry (EGA-MS) for the second region.

4. The positive electrode for a secondary battery according to claim 3,
wherein in a case where the positive electrode mixture layer is divided into ten in the thickness direction, and regions obtained by dividing the positive electrode mixture layer into ten are defined as an A region, a B region, a C region, a D region, an E region, an F region, a G region, an H region, an I region, and a J region in this order from the positive electrode current collector,
a ratio (W/V) of the highest proportion (W) of an element F among the proportions of the elements F derived from the binders contained in the respective regions of the D region, the E region, and the F region to the highest proportion (V) of an element F among the proportions of the elements F derived from the binders contained in the respective regions of the A region, the B region, and the C region is less than 1.3.

5. The positive electrode for a secondary battery according to claim 1, wherein the positive electrode active material contains a lithium composite oxide represented by General Formula: LiₐNiₓCo_{y}M_{1-x-y}O₂ (where a, x, and y satisfy 0.97≤a≤1.2, 0.8≤x≤1.0, and 0≤y≤0.2, respectively, and M includes at least one selected from the group consisting of Mn, Al, B, W, Sr, Mg, Mo, Nb, Ti, Si, and Zr).

6. A positive electrode for a secondary battery, comprising: a positive electrode current collector; and a positive electrode mixture layer that is provided on the positive electrode current collector and contains a positive electrode active material and a binder having a PVDF skeleton,
wherein in a case where the positive electrode mixture layer is divided into two in a thickness direction, a lower half on a side of the positive electrode current collector is defined as a first region, and an upper half on a surface side of the positive electrode mixture layer is defined as a second region, a generation initiation temperature of a peak observed from a temperature-chromatogram curve for a mass-to-charge ratio (m/z)=132 obtained by evolved gas analysis-mass spectrometry (EGA-MS) for the first region is higher than a generation initiation temperature of a peak observed from a temperature-chromatogram curve for a mass-to-charge ratio (m/z)=132 obtained by evolved gas analysis-mass spectrometry (EGA-MS) for the second region.

7. The positive electrode for a secondary battery according to claim 6,
wherein in a case where the positive electrode mixture layer is divided into ten in the thickness direction, and regions obtained by dividing the positive electrode mixture layer into ten are defined as an A region, a B region, a C region, a D region, an E region, an F region, a G region, an H region, an I region, and a J region in this order from the positive electrode current collector,
a ratio (W/V) of the highest proportion (W) of an element F among the proportions of the elements F derived from the binders contained in the respective regions of the D region, the E region, and the F region to the highest proportion (V) of an element F among the proportions of the elements F derived from the binders contained in the respective regions of the A region, the B region, and the C region is less than 1.3.

8. The positive electrode for a secondary battery according to claim 6, wherein the positive electrode active material contains a lithium composite oxide represented by General Formula: LiₐNiₓCo_{y}M_{1-x-y}O₂ (where a, x, and y satisfy 0.97≤a≤1.2, 0.8≤x≤1.0, and 0≤y≤0.2, respectively, and M includes at least one selected from the group consisting of Mn, Al, B, W, Sr, Mg, Mo, Nb, Ti, Si, and Zr).

9. A secondary battery comprising the positive electrode for a secondary battery according to claim 1.

10. A secondary battery comprising the positive electrode for a secondary battery according to claim 6.
